(19) United States
(12) Patent Application Publication
(10) Pub. No.: US 2013/0334909 A1
(43) Pub. Date: Dec. 19, 2013

(54) MOTOR

(71) Applicant: LG Innotek Co., Ltd., Seoul (KR)

(72) Inventors: JAE HYUN PARK, Seoul (KR); JAE JUN EOM, Seoul (KR); JUN KYU LEE, Seoul (KR); JA YOUNG SEO, Seoul (KR)

(21) Appl. No.: 13/917,076

(22) Filed: Jun. 13, 2013

(30) Foreign Application Priority Data
Jun. 15, 2012 (KR) 10-2012-0064172

(51) Int. Cl. H02K 5/24; H02K 3/32

(52) U.S. Cl. CPC H02K 5/24; H02K 3/32
USPC 310/51; 310/215

(57) ABSTRACT

Disclosed is a motor, the motor according to a first exemplary embodiment of the present disclosure including a housing, a stator mounted on the housing and including a stator core having a plurality of teeth, an insulator and a coil, a rotor rotatably installed at a center of the stator by a rotation shaft, and an insulation member wrapping an entire surface except for a surface opposite to the rotor of the stator, wherein the insulation member is arranged therein with an insulator and a coil.

### CROSS-REFERENCE TO RELATED APPLICATION

This application claims the benefit under 35 U.S.C. §119 of Korean Application No. 10-2012-0064172, filed Jun. 15, 2012, which is hereby incorporated by reference in its entirety.

### BACKGROUND OF THE INVENTION

1. Field of the Invention

The present disclosure relates to a motor having a stator and a rotor.

2. Description of the Related Art

Generally, almost every vehicle employs an electric power-assist steering system. Such an electric power-assist steering system generates an assist force based on the steering torque and the steering angle, so as to enhance the steering performance of the vehicle.

That is, a steering system that assists a steering force of a vehicle with a separate power is used to enhance the motion stability of a vehicle.

Conventionally, the auxiliary steering device uses hydraulic pressure, but an Electronic Power Steering (EPS) system adapted to transmit a rotation output of an electric motor to a steering shaft via a speed reduction mechanism has been increasingly employed these days from a viewpoint of a reduction in engine load, a reduction in weight, an enhanced steering stability and a quick restoring force.

The EPS system is such that an Electronic Control Unit (ECU) drives a motor in response to steering conditions detected by a speed sensor, a torque angle sensor and a torque sensor to enhance a steering stability and provide a quick restoring force, whereby a driver can safely steer a vehicle.

The EPS system is also such that a motor assists a torque manipulating a steering wheel to allow a driver to steer a vehicle with less power, where the motor employs a Brushless Direct Current (BLDC) motor.

The BLDC motors have been increasingly used because the brushless motors are excellent in maintenance property, have a small size, and are capable of generating a high torque.

The BLDC motor generally forms an exterior look by coupling of a housing and a cover member, an inner circumferential surface of the housing is provided with a stator, and the stator is centrally formed with a rotor rotatably mounted in electrical interaction with the stator. The rotor is rotatably supported by a rotation shaft, and an upper surface of the rotation shaft is connected by a steering shaft of a vehicle to provide a power assisting the steering of the vehicle as mentioned above.

Meanwhile, the cover member is installed at an inside thereof with a PCB (Printed Circuit Board) mounted with a detection sensor provided in the form of a magnetic element. The detection sensor detects a magnetic force of a sensing magnet installed in a rotationally interlocking way with the rotor to learn a current position of the rotor.

In general, the sensing magnet is fixed to an upper surface of a plate installed at an upper surface of the rotor using an adhesive. A rotor position can be detected by coupling the plate to a rotation shaft in response to a magnetic field direction, in a case the sensing magnet is magnetized to the plate.

However, there may be generated a trembling or a resonance of a stator core due to electromagnetic force generated during rotation of a rotor. The trembling of the stator core by the resonance may result in an increased noise during operation of the motor, an erroneous operation and/or decreased performance.

### BRIEF SUMMARY

The present disclosure is directed to cope with the abovementioned problems/disadvantages and it is an object of the present disclosure to provide a structure-improved motor configured to reduce vibration of a stator core.

In a first exemplary embodiment of the present disclosure, there is provided a motor, the motor comprising: a housing; a stator mounted on the housing and including a stator core having a plurality of teeth, an insulator and a coil; a rotor rotatably installed at a center of the stator by a rotation shaft; and an insulation member wrapping an entire surface except for a surface opposite to the rotor of the stator, wherein the insulation member is arranged therein with an insulator and a coil.

Preferably, but not necessarily, the insulation member may be formed with any one of a rubber, silicone and an epoxy molding.

Preferably, but not necessarily, the stator coated at an outside with the insulation member may take a shape of a ring flat at an upper surface and a bottom surface.

In a second exemplary embodiment of the present disclosure, there is provided a motor, the motor comprising: a housing; a stator mounted on the housing and including a stator core having a plurality of teeth, an insulator and a coil; a rotor rotatably installed at a center of the stator by a rotation shaft; and a vibration prevention unit installed between the stator and the housing to prevent generation of vibration by regulating a movement of the stator.

Preferably, but not necessarily, the housing may include an upper housing and a bottom housing, and the vibration prevention unit may include a first pressure rib interposed between the insulator and the upper housing to apply pressure to the insulator, and a second pressure rib interposed between the insulator and the bottom housing to apply a pressure to the insulator.

Preferably, but not necessarily, each of the first and second pressure ribs may be brought into contact with each object.

Preferably, but not necessarily, the first pressure rib may be extensively and integrally formed with a surface opposite to the upper housing of the insulator.

Preferably, but not necessarily, the second pressure rib may be protrusively formed at a surface opposite to the insulator of the bottom housing to support a floor surface of the insulator.

In a third exemplary embodiment of the present disclosure, there is provided a motor, the motor comprising: a housing; a stator mounted on the housing and including a stator core having a plurality of teeth, each tooth distanced from the other tooth at a predetermined distance, an insulator and a coil; a rotor rotatably installed at a center of the stator by a rotation shaft; and a contact unit formed by mutual connection of each distal end of a portion wrapping the tooth of the insulator, wherein vibration of the stator core is absorbed by the contact unit.

Preferably, but not necessarily, the motor may further comprise an insulation member wrapping an entire surface except for a surface opposite to the rotor of the stator, wherein the configuration of the motor is same as that of the first embodiment.

Preferably, but not necessarily, the motor may further comprise a vibration prevention unit installed between the stator and the housing to prevent generation of vibration by regulating a movement of the stator, wherein the configuration of the motor is same as that of the second exemplary embodiment.

In an advantageous effect, a motor according to an exemplary embodiment of the present disclosure can prevent generation of resonance occurring on a stator core to reduce an operational noise of the motor, to prevent occurrence of erroneous operation of the motor caused by resonance of the stator core and to prevent generation of decreased performance.

### BRIEF DESCRIPTION OF THE DRAWINGS

FIG. 1 is a cross-sectional view illustrating a motor according to a first exemplary embodiment of the present disclosure.

FIG. 2 is a perspective view illustrating a stator core of FIG. 1.

FIG. 3 is a cross-sectional view illustrating a motor according to a second exemplary embodiment of the present disclosure.

FIG. 4 is a plan view illustrating a stator core and an insulator according to a third exemplary embodiment of the present disclosure.

### DETAILED DESCRIPTION

Now, a motor according to the exemplary embodiments of the present disclosure will be described in detail with reference to the accompanying drawings.

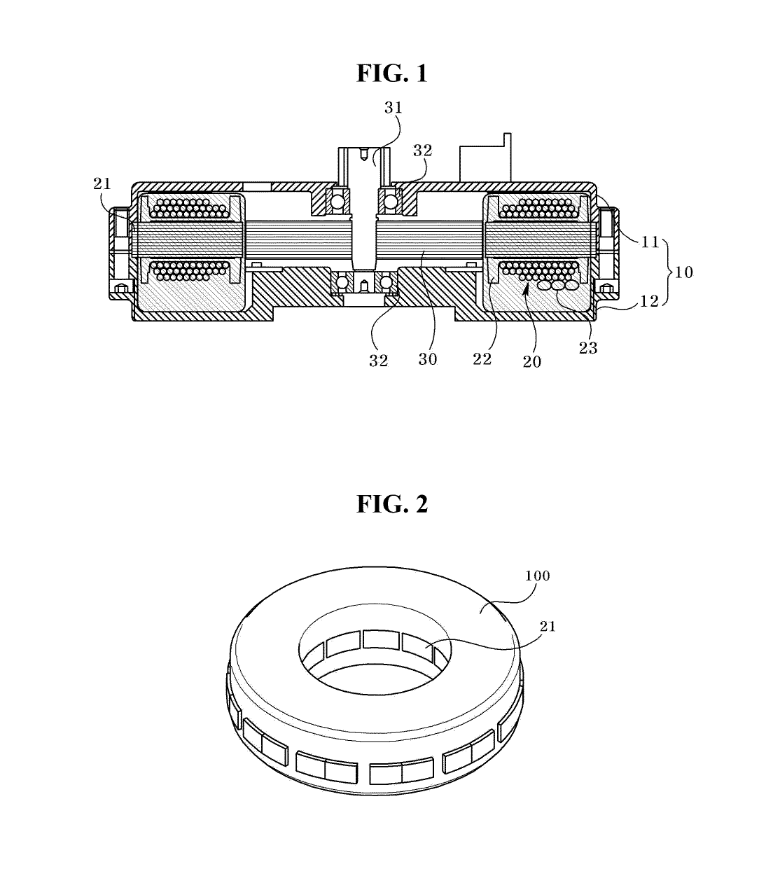

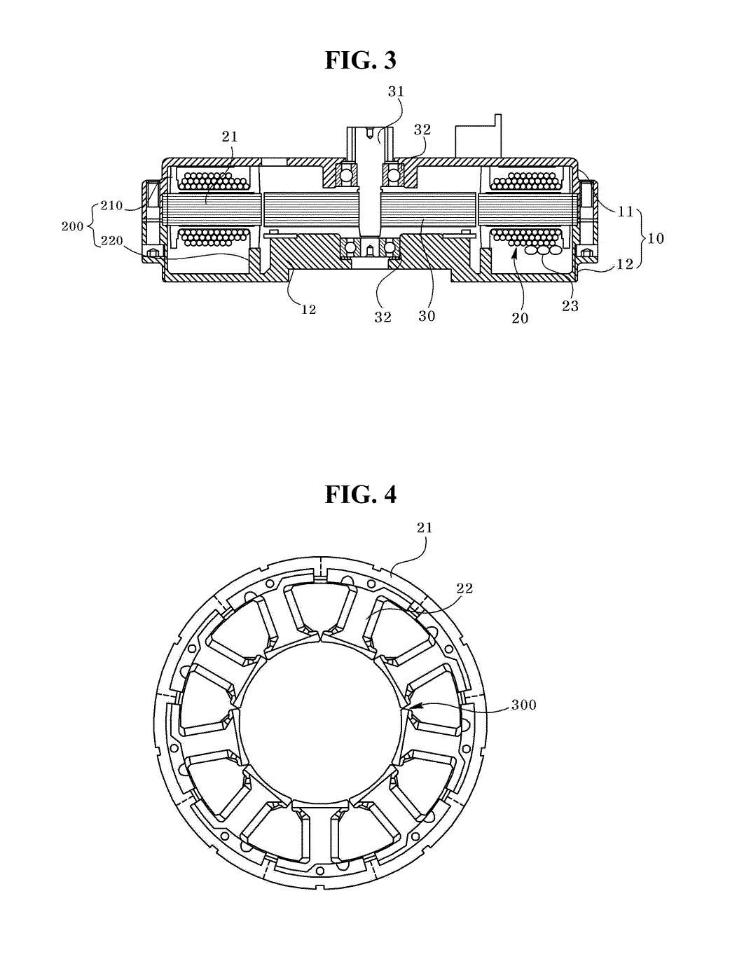

FIG. 1 is a cross-sectional view illustrating a motor according to a first exemplary embodiment of the present disclosure, FIG. 2 is a perspective view illustrating a stator core of FIG. 1, FIG. 3 is a cross-sectional view illustrating a motor according to a second exemplary embodiment of the present disclosure, and FIG. 4 is a plan view illustrating a stator core and an insulator according to a third exemplary embodiment of the present disclosure.

Referring to FIG. 1, the motor includes a housing (10), a stator (20) and a rotor (30). The housing (10) may include an upper housing (11) and a bottom housing (12), and a stator (20) wound with a plurality of coils may be installed inside a space formed by coupling of the upper housing (11) and the bottom housing (12). The stator (20) may include a stator core (21), an insulator (22) and a coil (23).

The stator core (21) may be provided with a block of metal material, and may be formed by stacking a plurality of sheets of core members each formed with a thin plate. The stator core (21) may be protrusively formed with a plurality of teeth facing a surface opposite to the rotor (30) and each tooth is wound with the coil (23).

The insulator (22) may be coupled to an upper surface and a bottom surface of the stator core (21) and serves to prevent the coil (23) wound on the teeth from being electrically conducted with the stator core (21). The insulator (22) may be formed with a resin material. The rotor (30) is rotatably formed at a center of the stator (20) by a rotation shaft (31).

The rotor (30) may be formed by a magnet being coupled to a rotor core, and in some instances, the rotor core and the magnet may be integrally formed.

Both distal ends of the rotation shaft (31) are preferably and rotatably supported by a bearing (32). An upper surface of the rotor (30) may be installed with a plate coupled to a sensing magnet for obtaining position information of the rotor (30), or may be installed with rotor position detecting means similar to the sensing magnet.

The characteristic of the present disclosure lies in a configuration for preventing resonance of the stator (20) installed inside a space of the housing (10), and may be divided into the following exemplary embodiments.

According to a first exemplary embodiment of the present disclosure, the insulator (22)-equipped stator (20) may be coated at an outside wound with the coil (23), with an insulation member (100) to allow the outside of the stator (20) to be wrapped with the insulation member (100), as illustrated in FIGS. 1 and 2, and the space of the stator (20) inside the housing (10) may be fully filled with the stator (20) wound with the insulation member (100), as shown in FIG. 1. According to the configuration thus illustrated, an intrinsic frequency of the stator (20) is changed as the stator (20) is coated with the insulation member (100) to thereby reduce vibration caused by the resonance. In addition, the insulation member (100) wrapping the stator (20) may surface-contact an inner surface of the upper and bottom housings (11, 12) to cause the vibration generated by electromagnetic force of the rotor (30) and the stator (20) to be absorbed by the insulation member (100) and the upper and bottom housings (11, 12). Thus, the vibration of the stator (20) generated in the course of motor operation can be restricted to enhance a reduced noise and operational reliability of a motor.

FIG. 3 is a cross-sectional view illustrating a motor according to a second exemplary embodiment of the present disclosure.

Referring to FIG. 2, most of the configurations according to the second exemplary embodiment are same as those of the first embodiment, except that shapes of the insulator (22) and the bottom housing (12) are partially changed and a vibration prevention unit (200) is added.

That is, a surface opposite to the upper housing (11) of the insulator (22) may be formed with a first pressure rib (210) extensively formed as long as a length capable of surface-contacting an inner surface of the upper housing (11) to allow the first pressure rib (210) to surface-contact all the inner surface of the upper housing (11). In addition, a floor surface facing the insulator (22) of the bottom housing (12) may be protrusively formed with a ring-shaped second pressure rib (220) applying a pressure to the insulator (22).

The second pressure rib (220) may be formed at a position corresponding to a floor surface of the insulator (220) wrapping the teeth as illustrated in FIG. 3. The present disclosure is not limited thereto. Alternatively, the second pressure rib (220) may be formed at any place configured to support the floor surface of the insulator (22).

According to the configuration thus described, an upper surface of the insulator (22) may surface-contact the upper housing (11) via the first pressure rib (210), and a bottom surface of the insulator (22) may surface-contact the bottom housing (12) via the second pressure rib (220) to reduce the vibration caused by the resonance as the intrinsic frequency of the stator core (21) is changed. Furthermore, the vibration that may be generated by the electromagnetic force of the rotor (30) and the stator (20) may be absorbed by the insulation member (100) and the upper and bottom housings (11, 12) as the inner surface of the upper and bottom housings (11, 12) is surface-contacted with the insulator (22).

Hence, the vibration of the stator (20) that may be generated in the course of motor operation can be restricted to enhance the reduced noise and operational reliability of motor.

FIG. 4 is a plan view illustrating a stator core and an insulator according to a third exemplary embodiment of the present disclosure.

Referring to FIG. 4, the insulator (22) is configured to wrap the teeth formed at the stator core (21), such that in a case the teeth are wound with the coil (23), the stator core (21) is prevented from being short-circuited.

However, a surface facing the teeth and the rotor (30) is exposed with the teeth of the stator core (21) and each tooth is spaced apart from the other tooth at a predetermined distance.

In the third exemplary embodiment of the present disclosure, a contact unit (300) may be formed in which tooth portions of the insulator (22) wrapping the teeth are mutually touched, while maintaining each of the spaced-apart distances of the teeth unchanged.

According to the configuration above mentioned, the insulators (22) wrapping each tooth are mutually connected at the contact unit (300), whereby vibration that may be generated from the stator core (21) can be absorbed by the contact unit (300) of the insulator (22) to reduce the vibration that may be generated in the course of motor operation.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

What is claimed is:

1. A motor, the motor comprising:
a housing;
a stator mounted on the housing and including a stator core having a plurality of teeth, an insulator and a coil;
a rotor rotatably installed at a center of the stator by a rotation shaft; and
an insulation member wrapping an entire surface except for a surface opposite to the rotor of the stator, wherein the insulation member is arranged therein with an insulator and a coil.

2. The motor of claim 1, wherein the insulation member is formed with any one of a rubber, silicone and an epoxy molding.

3. The motor of claim 1, wherein the stator coated at an outside with insulation member takes a shape of a ring flat at an upper surface and a bottom surface.

4. A motor, the motor comprising:
a housing;
a stator mounted on the housing and including a stator core having a plurality of teeth, an insulator and a coil;
a rotor rotatably installed at a center of the stator by a rotation shaft; and
a vibration prevention unit installed between the stator and the housing to prevent generation of vibration by regulating a movement of the stator.

5. The motor of claim 4, wherein the housing includes an upper housing and a bottom housing, and the vibration prevention unit includes a first pressure rib interposed between the insulator and the upper housing to apply pressure to the insulator, and a second pressure rib interposed between the insulator and the bottom housing to apply a pressure to the insulator.

6. The motor of claim 5, wherein each of the first and second pressure ribs is brought into contact with each object.

7. The motor of claim 5, wherein the first pressure rib is extensively and integrally formed with a surface opposite to the upper housing of the insulator.

8. The motor of claim 5, wherein the second pressure rib is protrusively formed at a surface opposite to the insulator of the bottom housing to support a floor surface of the insulator.

9. A motor, the motor comprising:
a housing;
a stator mounted on the housing and including a stator core having a plurality of teeth, each tooth distanced from the other tooth at a predetermined distance, an insulator and a coil;
a rotor rotatably installed at a center of the stator by a rotation shaft; and
a contact unit formed by mutual connection of each distal end of a portion wrapping the tooth of the insulator, wherein vibration of the stator core is absorbed by the contact unit.

10. The motor of claim 9, further comprising an insulation member wrapping an entire surface except for a surface opposite to the rotor of the stator, wherein the insulation member is arranged therein with an insulator and a coil.

11. The motor of claim 10, wherein the insulation member is formed with any one of a rubber, silicone and an epoxy molding.

12. The motor of claim 9, wherein the stator coated at an outside with insulation member takes a shape of a ring flat at an upper surface and a bottom surface.

13. The motor of claim 9, further comprising a vibration prevention unit installed between the stator and the housing to prevent generation of vibration by regulating a movement of the stator.

14. The motor of claim 13, wherein the housing includes an upper housing and a bottom housing, and the vibration prevention unit includes a first pressure rib interposed between the insulator and the upper housing to apply pressure to the insulator, and a second pressure rib interposed between the insulator and the bottom housing to apply a pressure to the insulator.

15. The motor of claim 14, wherein each of the first and second pressure ribs is brought into contact with each object.

16. The motor of claim 14, wherein the first pressure rib is extensively and integrally formed with a surface opposite to the upper housing of the insulator, and the second pressure rib is protrusively formed at a surface opposite to the insulator of the bottom housing to support a floor surface of the insulator.
